(19) United States
(12) Patent Application Publication
(10) Pub. No.: US 2014/0325579 A1
(43) Pub. Date: Oct. 30, 2014

(54) SYSTEM FOR BROADCASTING, STREAMING, AND SHARING OF LIVE VIDEO

(71) Applicant: Joseph SCHUMAN, New York, NY (US)

(72) Inventor: Joseph SCHUMAN, New York, NY (US)

(21) Appl. No.: 14/216,284

(22) Filed: Mar. 17, 2014

Related U.S. Application Data
(60) Provisional application No. 61/791,757, filed on Mar. 15, 2013.
(60) Provisional application No. 61/917,696, filed on Dec. 18, 2013.

(51) Int. Cl. H04N 21/2187

(52) U.S. Cl. CPC H04N 21/2187
USPC 725/116

(57) ABSTRACT

A media distribution system is disclosed, and comprises a head-mounted user media device, a plurality of viewer media devices, and a media server. The head-mounted user media device includes at least one sensor substantially aligned with a user's field of view and configured to generate media content. Each media device of the plurality of viewer media devices is configured to display media content from the head-mounted user media device. The media server interconnects the head-mounted user media device and the plurality of viewer media devices across a data network. The media server comprising a processor to implement one or more criteria provided by the user such that one or more selected viewer media devices can receive media content from the head-mounted user media device through the media server.

### CROSS-REFERENCE TO RELATED APPLICATIONS

The present application claims the benefit of, and priority to, U.S. Provisional Patent Application No. 61/791,757, filed on Mar. 15, 2013, and the present application claims the benefit of and priority to U.S. Provisional Patent Application No. 61/917,696, filed on Dec. 18, 2013, the entire contents of each of which is incorporated by reference herein.

### FIELD

The present disclosure generally relates to systems, program products, and methods of using the same for facilitating the generation, storage, and/or distribution of media content from a media device. In exemplary embodiments, the present disclosure further relates to systems, program products, and methods of using the same for facilitating the generation, storage, and/or distribution of live first-person perspective media content from a media device that is mounted on a user in substantial alignment with a user's field of view.

### BACKGROUND

Traditionally, media content such as audio and/or video was generated and/or distributed by dedicated content providers such as television and film production entities, and largely included scheduled and/or scripted programming. However, the increasing availability of personal-use media devices adapted to generate media content, for example, smartphones, tablet computers, and/or other portable electronic recording devices, has created an expansive community of users capable of generating media content. Such user-generated media content may be non-traditional in that includes a large volume of amateur and/or unscripted media content that may be desirably considered “raw” by potential viewers.

The development of personal-use media devices that are wearable on a portion of a user's body, for example, head-mounted displays (“HMDs”) and smartwatches, to name a few, have presented an increased potential to generate first-person media content because such wearable media devices may be oriented on a user to capture media content from a similar perspective to the user who is physically witnessing the captured event. Such first-person media content may be desirable to potential viewers that value the voyeuristic experience provided by media content created from a first-person perspective, and in particular live media content that is viewable substantially in real-time.

Accordingly, it would be desirable to provide a system to facilitate the distribution of media content from one or more of such media devices to one or more viewers across a data network. Additionally or alternatively, it would be desirable to provide a system to facilitate the transmission of first-person media content from one or more wearable media devices across a data network substantially real-time in a centralized and easily accessible manner.

### SUMMARY

According to an exemplary embodiment, a media distribution system comprises a head-mounted user media device, a plurality of viewer media devices, and a media server. The head-mounted user media device includes at least one sensor substantially aligned with a user's field of view and configured to generate media content. Each media device of the plurality of viewer media devices is configured to display media content from the head-mounted user media device. The media server interconnects the head-mounted user media device and the plurality of viewer media devices across a data network. The media server comprising a processor to implement one or more criteria provided by the user such that one or more selected viewer media devices can receive media content from the head-mounted user media device through the media server.

In an exemplary embodiment, the media content comprises video.

In an exemplary embodiment, the media content comprises audio.

In an exemplary embodiment, the head-mounted user media device comprises a display.

In an exemplary embodiment, the display comprises media content generated from the sensor.

In an exemplary embodiment, the display comprises a graphic user interface which displays information relating to one or more components of the media distribution system.

In an exemplary embodiment, the head-mounted user media device comprises a transmitter such that media content from the head-mounted user media device can be transmitted across the data network substantially in real-time.

In an exemplary embodiment, the one or more criteria comprises a subscription.

According to an exemplary embodiment, a media distribution system comprises a plurality of head-mounted user media devices, a viewer media device, and a media server. Each head-mounted user media device of the plurality of head-mounted user media devices includes at least one sensor substantially aligned with a respective user's field of view and configured to generate media content. The viewer media device is configured to display media content from each of the head-mounted user media devices to a viewer. The media server interconnects the plurality of head-mounted user media devices and the viewer media device across a data network. The media server comprises a processor to implement one or more criteria provided by the viewer such that media content from one or more of the plurality of head-mounted user media devices is provided for selection by the viewer.

In an exemplary embodiment, the one or more of the plurality of head-mounted user media devices comprises less than the plurality of head-mounted user media devices.

In an exemplary embodiment, the media content comprises video.

In an exemplary embodiment, the media content comprises audio.

In an exemplary embodiment, the viewer media device comprises a graphic user interface which displays information relating to one or more components of the media distribution system.

In an exemplary embodiment, the one or more criteria comprises a common identifier.

In an exemplary embodiment, the common identifier is a topic.

In an exemplary embodiment, the common identifier is media content that is transmitted substantially in real-time.

According to an exemplary embodiment of the present disclosure, a method of using a head-mounted user media device comprises: (a) providing a head-mounted user media device mounted in substantial alignment with a user's field of view and comprising a sensor configured to generate media content and a transmitter to transmit media content across a data network; (b) activating the sensor such that media content is generated; (c) transmitting the media content across the data network to a media server substantially in real-time; and (d) selecting one or more criteria determining access of the media content from the media server by one or more viewers.

In an exemplary embodiment, the step of selecting one or more criteria includes the one or more criteria being a subscription.

In an exemplary embodiment, the step of activating the sensor includes speaking by the user a voice command.

### BRIEF DESCRIPTION OF THE DRAWINGS

Various exemplary embodiments of this invention will be described in detail, with reference to the following figures, wherein:

FIG. 1 is a schematic diagram of a media distribution system according to an exemplary embodiment of the present disclosure;

FIG. 2 is a schematic diagram of the area of detail identified in FIG. 1;

FIG. 3 is a schematic diagram illustrating the flow of media along a portion of the media distribution system of FIG. 1;

FIG. 4 is a perspective view of a user operating a user device of the system of FIG. 1;

FIG. 5 is a detail view of the user device of FIG. 4;

FIG. 6 is a schematic view of the area of detail identified in FIG. 5;

FIG. 7 is a graphic user interface of the user device of the system of FIG. 1 according to an exemplary embodiment of the present disclosure;

FIG. 8 is a graphic user interface of a viewer device of the system of FIG. 1 according to an exemplary embodiment of the present disclosure;

FIG. 9 is a graphic user interface of a viewer device of the system of FIG. 1 according to another exemplary embodiment of the present disclosure;

FIG. 10 is a graphic user interface of a viewer device of the system of FIG. 1 according to another exemplary embodiment of the present disclosure.

### DETAILED DESCRIPTION

In embodiments, the present disclosure generally relates to systems, program products, and methods of using the same for facilitating the generation, storage, and/or distribution of media content from a media device. In exemplary embodiments, the present disclosure further relates to systems, program products, and methods of using the same for facilitating the generation, storage, and/or distribution of live first-person perspective media content from a media device that is mounted on a user in substantial alignment with the user's field of view.

As used herein, the term media content will be understood to include audio and/or video content such as sound recordings, still photographs, and movies of any length, to name a few. In embodiments, it will be understood that video media content may be provided with accompanying audio, or may be devoid of audio. Such media content may be provided in various formats, and in exemplary embodiments, a data stream or electronic file, to name a few.

As used herein, the term media device will be understood to include any device that is capable of receiving an input such as light, sound, and/or electronic data, and transforming the input into electronic data. In exemplary embodiments, media devices may include smartphones, tablet computers, laptop computers, digital cameras, and/or digital sound recorders, to name a few. Further, the term wearable media device will be understood to include any media device that is adapted for mounting on one or more portions of a user's body, and in exemplary embodiments, refers to a head-mounted display such as Google Glass™ (hereinafter, “HMD”).

As user herein, the term user will be understood to refer to an operator, such as a person, of a media device. Further, the term viewer will be understood to refer to the operator of a device adapted to receive media content generated from one or more media devices and project video and/or sound corresponding to the media content. In embodiments, such viewer media devices may include smartphones, tablet computers, laptop computers, desktop computers, and/or HMDs, to name a few. In embodiments, a single media device may operate simultaneously and/or alternately as a user media device and a viewer media device.

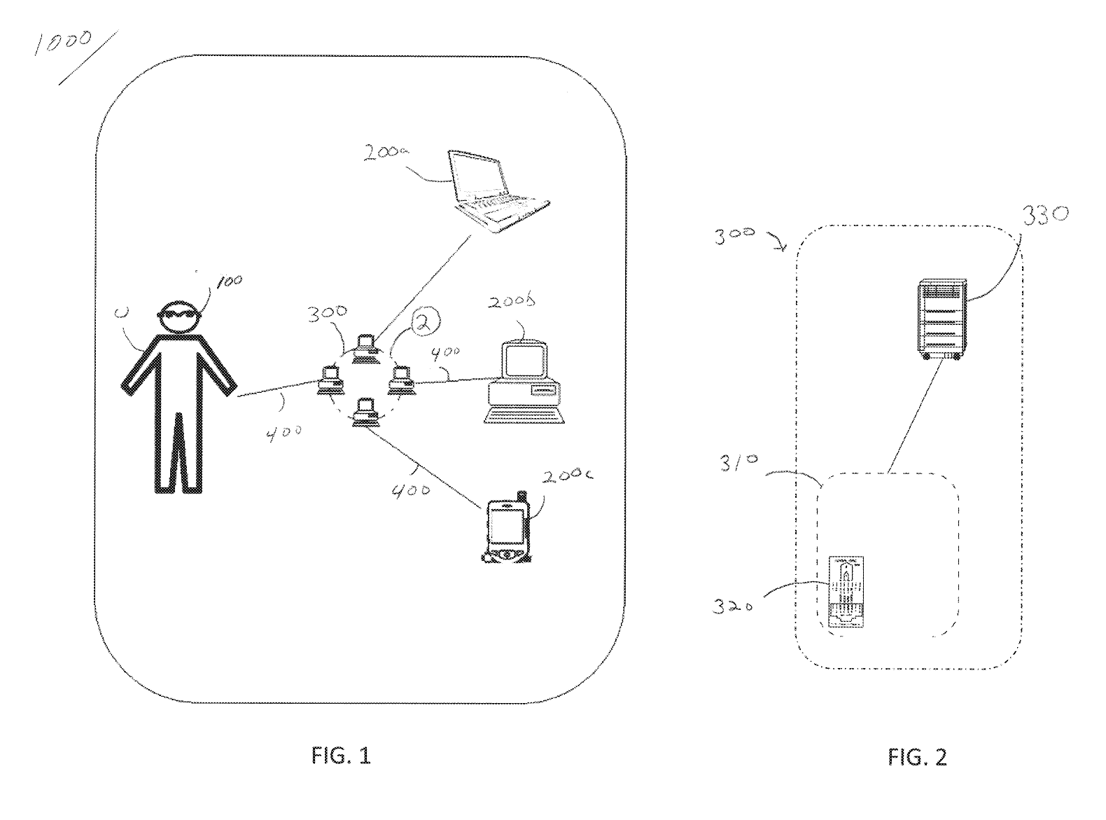

Turning to FIG. 1, an exemplary embodiment of a media distribution system is generally designated 1000. Media distribution system 1000 may be an interconnection of elements that comprise at least a user media device 100, viewer media devices 200a, 200b, and 200c, and a media server 300. It will be understood that while three viewer media devices are illustrated, in exemplary embodiments, a media distribution system may include any number of user media devices, viewer media devices, and media servers in any separation or combination thereof. In embodiments, the number of user media devices and/or viewer devices may be proportional to a number of members in a given population.

User media device 100, viewer media devices 200a, 200b, 200c, and/or media server 300, and/or any component thereof, may be interconnected along one or more electronic data networks 400, for example, a wired and/or wireless data communication system such as the World Wide Web, a mobile data network, and/or local intranet, to name a few.

As described further herein, media distribution system 1000 is configured to facilitate the transmission of media content from user media device 100 to one or more of viewer media devices 200a, 200b, 200c according to one or more criteria selected by the user and/or one or more viewers and implemented by media server 300. In exemplary embodiments, distribution criteria may include, for example, user-defined authorized viewers associated with respective media devices 200a, 200b, 200c, system-defined authorized viewers associated with respective media devices 200a, 200b, 200c, and/or respective media devices 200a, 200b, 200c of viewers associated with an identifier such as geography, topic, hobby or interest, or demographic, to name a few.

In embodiments, authorized viewers may be associated with a user via a prior association in a third-party social network, for example, Facebook™, Twitter™, or LinkedIn™, to name a few. In such embodiments, media distribution system 1000 may facilitate connectivity with a third-party social network, for example, via a web-based plugin, such that a user may communicate information relating to media distribution system 1000 to a contact on a third-party social network in an automated manner. Accordingly, media content can be transmitted to viewer media devices 200a, 200b, 200c in any combination and/or separation desired by the user.

Turning to FIG. 2, media server 300 may comprise a program product 310 and at least one electronic data store 320 in communication with program product 310. Program product 310 may be a computer-implemented application operable via one or more processors 312. In particular, program product 310 may include a non-transitory computer-readable medium on which are stored instructions read by the one or processors 312 to carry out the various functions of the media server 300. In embodiments, program product 310 may comprise a computing environment having one or more real and/or virtual data servers to provide network-based services to a user, such as a cloud computing environment, and provides a hub connecting user media device 100 and at least viewer media devices 200a, 200b, 200c along data network 400. Product program 310 is accessible through data network 400 by user device 100 and viewer media devices 200a, 200b, 200c and may comprise one or more graphic user interfaces, described further herein, so that users and/or viewers can communicate preferences and/or settings to media server 300.

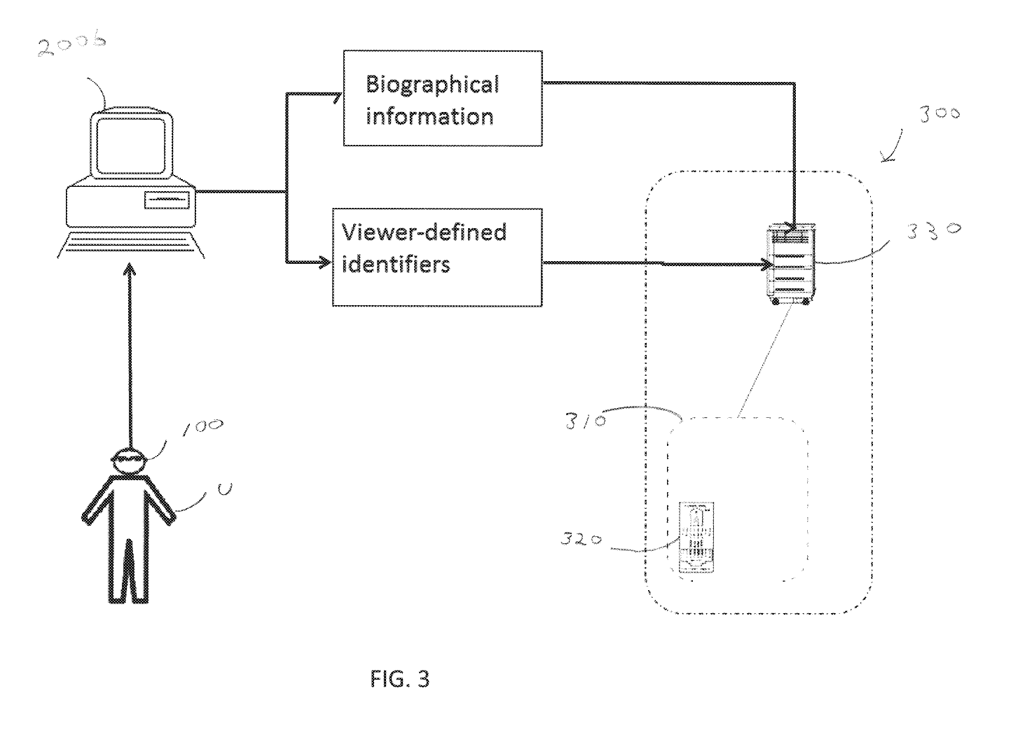

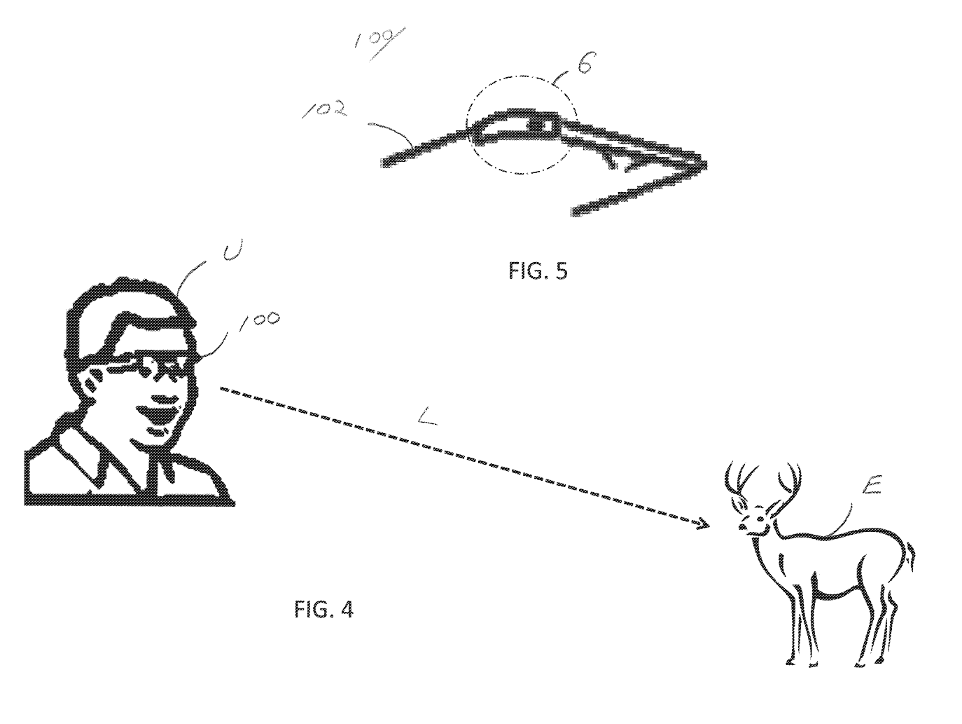

With additional reference to FIG. 3, implementation of a number of user-defined criteria by media server 300 to control distribution of media across media distribution system 1000 is shown. It will be understood that a user may implement such criteria relating to the distribution of media content at any time including before, during, and after operation of user media device 100. It will be understood that user-defined criteria may be input to media server 300, for example, by tactile, motion, and or voice-activated inputs directly through user media device 100 and/or through a device separate from user media server 300, for example, a HMD, tablet computer, or smartphone connected to media server 300 across data network 400. As described above, media server 300 may comprise an electronic data store 320 for storage of user-defined criteria. In embodiments, such user-defined criteria may include default preferences and/or conditions under which media content is distributed to one or more groups of viewer devices connected to media distribution network 1000. In exemplary embodiments, such groups may be defined by: username, common identifiers, subscription (to facilitate private media distribution to only subscribed viewers), geographic location, and/or social media contacts, to name a few. Such user-defined criteria may be implemented by processor 320 to control combinations and/or separations of viewer media devices that can receive media content generated by a particular user media device 100.

Similarly, it will be understood that a viewer operating a respective viewer media device 200a, 200b, 200c may implement viewer-defined criteria to media server 300 via product program 310, as described further herein. Viewers operating respective viewer media devices 200a, 200b, 200c may further input one or more identifiers into media server 300 via product program 310, for example, a username, geographic location, biographical identifier, group membership, and/or subscription to name a few. Such identifiers can be stored on electronic data store 320 and compared to the user-defined criteria described above during operation of the media distribution system 1000 to control combinations and/or separations of viewer media devices that can receive media content generated by a particular user media device 100.

Referring to FIGS. 4 and 5, an exemplary embodiment is shown of a user U generating media content with a user media device 100 being an HMD. Media device 100 may approximate, for example, a pair of eyeglass frames and include a frame 102 comprising a pair of arms extending parallel to one another and orthogonally connected by a bridge that rests upon the nose of user U. Accordingly, each of the pair of arms may extend rearwardly along the lateral sides of the head of user U and rest upon the ears of user U so that the connecting bridge rests upon the nose of user U so that frame 102 is disposed in substantial vertical alignment with the field of vision of user U. Media device 100 further includes a media component 110 mounted along the frame 102 and configured to generate, store, and/or transmit media content along data network 400. Media component 110 may include a display 112 oriented on the frame 102 to be visible by the user U, as will be described further below. One or more user controls (not shown) may be disposed on media device 100 to control various operations thereof, as will be described further below. In embodiments, it will be understood that such user controls may have any configuration suitable for their intended purpose, for example, buttons, switches, knobs, capacitive touchscreens and/or touchpads, and/or sensors for motion- and/or voice-activated controls, to name a few. In embodiments, it will be understood that a media device may have any desirable configuration for its intended purpose.

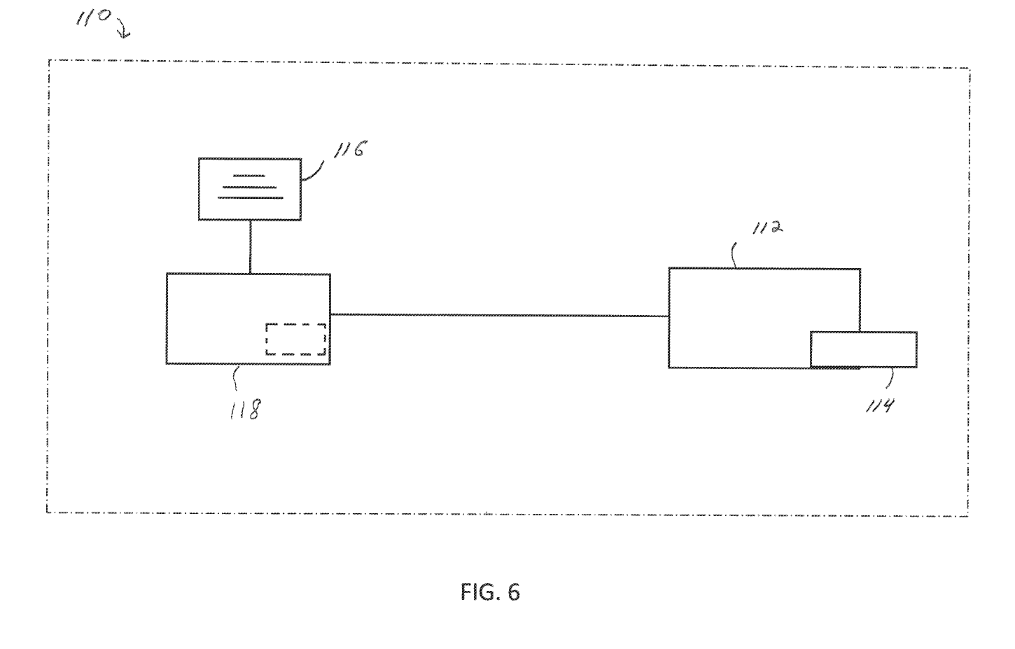

With additional reference to FIG. 6, a schematic diagram of the media component 110 of user media device 100 is shown. Media component 110 may comprise at least one sensor 114 such as a photo and/or audio sensor electrically coupled to a transmitter 116 that is adapted to transmit data along data network 400. Accordingly, transmitter 116 may be an antenna, for example, for a mobile wireless data network or local Wi-Fi internet connection, to name a few. Media component 110 may additionally comprise a processor 118 for transforming data into a format that can be visualized on display 112 or another output component of media component 110, for example, an audio speaker. Processor 118 may additional facilitate the interoperation of any of display 112, sensor 114, transmitter 116, and/or any user controls of media device 100. In embodiments, user media device 100 may additionally incorporate a data storage device for the temporary and/or indefinite storage of media content, such as DRAM or flash memory, to name a few.

Still referring to FIGS. 4, 5, and 6, operation of the user media device 100 will be described. User U fitted with the user media device 100 (HMD) may be near an event E, such as a performance, announcement, emergency, disaster, or the like, and can activate user media device 100 via one or more controls as described above to activate sensor 114. For example, user may speak a command such as “on,” “activate,” “record,” or “broadcast,” to name a few, to activate generation of media content via activation of sensor 114. Accordingly, sensor 114 generates and media content data to processor 118 for transformation into a format visible to the user U on display 112. In embodiments, sensor 114 may send media content data to other output components of user media device 100, such as sound data to a speaker.

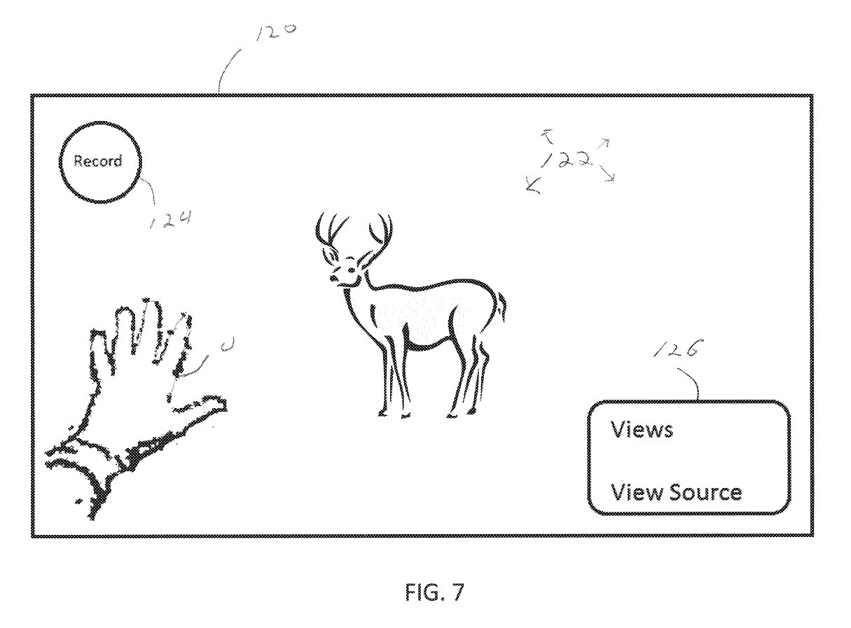

Turning now to FIG. 7, and still referring to FIGS. 4 and 5, media content is shown on the display 112 of from the perspective of user U. Display 112 of media device 100 or any other media device described herein may be of any suitable format to display video, for example, LCD screen, LED screen, plasma screen, and/or a projector screen, to name a few. In embodiments, a display 112 may be in the form of a capacitive touchscreen such that display 112 is configured to display media content as well as accept user inputs to control aspects of a media device or other component of media distribution system 1000. As shown, display 112 shows a field of view 122 encompassing the video media content captured by sensor 114. Because the user media device 110 of the present embodiment is an HMD, the field of view 122 may represent a peripheral area along a line of sight L in front of the user U. As described further herein, field of view 122 may correspond to the video media content that is visible to a viewer using one of viewer media devices 200a, 200b, 200c. In this manner, user U may compare his or her physical field of view to the field of view 122 shown on display 112 to determine an appropriate position, for example, distance, height, and/or angle, from which to view an event E to capture media content that he or she desires to distribute via system 1000.

In embodiments, display 112 may provide information to a user in addition to media content being generated. In this manner, the field of view 122 may be a part of a graphic user interface 120 shown on display 112. As shown, graphic user interface 120 may comprise a status icon 124 corresponding to a state of operation of the user media device 100. In the exemplary embodiment shown, the presence of status icon 124 illustrates to user U that sensor 114 is active and that user device 100 is generating media content.

In embodiments, graphic user interface 120 may further comprise a counter field 126 that may display information relating to the number of viewer media devices currently receiving media content generated from the user media device 100. Such information may further include information relating to the population of viewer media devices receiving such media content, for example, geographic location, IP address, GPS location, username, social network, and/or individual identifiers, to name a few.

One or more graphic user interfaces may be provided for viewer media devices 200a, 200b, 200c, and may include one or more indicia relating to a status of operation of a media device, media server, and/or data network, and additionally or alternatively may correspond to a statistic of a portion of media distribution system 1000, such as strength or quality of connection to a data network 400 or whether or not another user or viewer is connected to media server 300, to name a few. Such indicia may be overlaid over media content, or may be spaced therefrom.

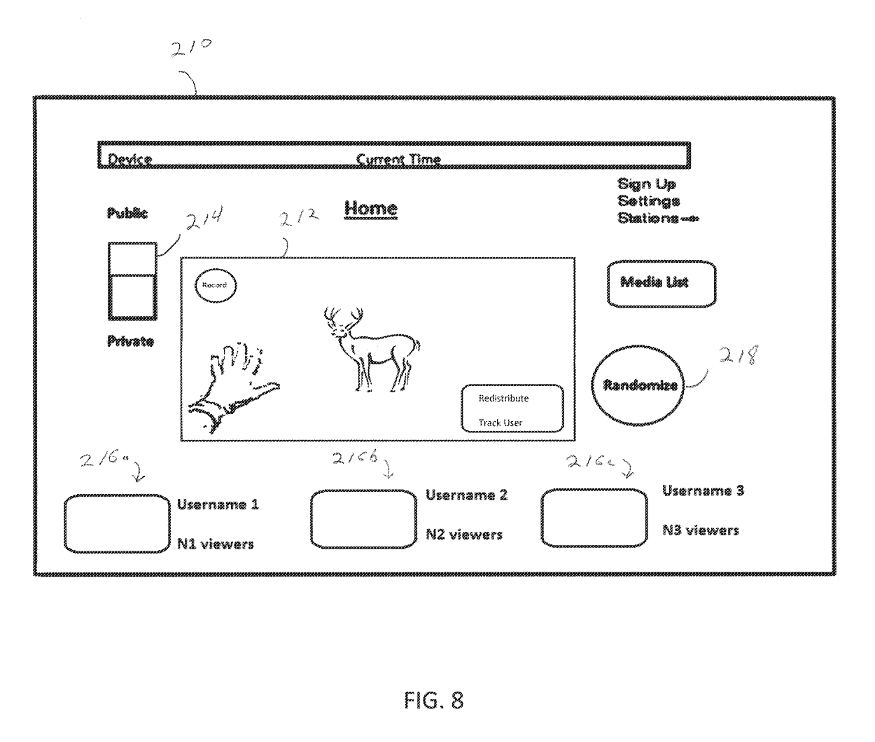

Turning now to FIG. 8, a graphic user interface 210 of one or more of viewer media devices 200a, 200b, 200c is shown according to an exemplary embodiment. Graphic user interface 210 may comprise a content field of view 212 that corresponds to the field of view 122 (FIG. 7) captured by user media device 100. In this manner, the content field of view 212 provides a viewer with a first-person perspective of an event E. In embodiments where media content is in the form of a live stream, a viewer is afforded a virtual presence to a live, unscripted event such that the viewer becomes more than a mere observer, and is provided with the sensation of playing witness to the event E. For example, depending on the event that is the subject of a given media content, a user may be provided with a first-person experience from the perspective of a performer or athlete, or a third-party observer thereof.

Graphic user interface 210 further comprises information relating to media content generated by other user media devices connected to media server 300 so that graphic user interface 210 allows a viewer to experience one source of media content while being presented with information corresponding to alternative sources of media content substantially in real-time. As shown, graphic user interface 210 may include a toggle 212 that allows a viewer to display privately-available (subscription based) or publicly-available (non-subscription based) media content. Accordingly, graphic user interface 210 may provide alternative sources of media content 216a, 216b, 216c that are generated from a user device other than user device 100. Alternative sources of media content 216a, 216b, 216c may be shown with any form of identifying information, for example, a representative still image or movie clip of any length, associated username, associated social network, and/or number of views, to name a few. In embodiments, sources of media content 216a, 216b, 216c may be displayed based on a ranking, for example, a ranking value based on the cumulative number of views of the sources of media content 216a, 216b, 216c. In this manner, the sources of media content 216a, 216b, 216 may change upon receiving updated information from media server 300.

In embodiments, a randomization option 218 may be provided on graphic user interface 210, and may be selected by a user to connect to a source of media content randomly selected from media server 300.

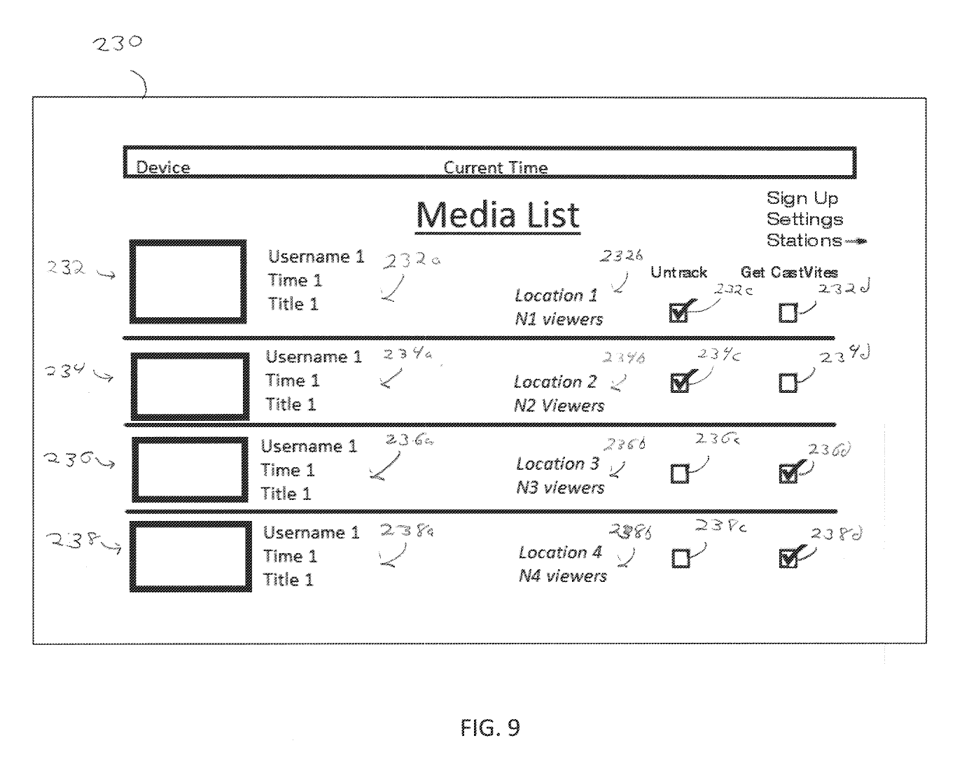

Turning to FIG. 9, an exemplary embodiment of a graphic user interface, designated 230, is shown. Graphic user interface 230 may provide a viewer with detailed information regarding available sources of media content, and may be devoid of actively-displayed media content such that the viewer is not required to select a source of media content while engaged in experiencing another. As shown, graphic user interface 230 may comprise a plurality of sources of media content 232, 234, 236, 238 accompanied by respective identifiers 232a, 234a, 236a, 238a. Such identifiers, as shown, may comprise username, starting time of media content generation, and a descriptive title. It will be understood that identifiers 232a, 232a, 236a, 238a may include any suitable identifying information, and may be set by default or chosen by a viewer. Graphic user interface 230 may additionally display respective data 232b, 234c, 236d, 238e relating to the media content. In embodiments, such data may include a location from which a media content is being generated and/or an associated number of views of the media content. Graphic user interface 230 may also provide a viewer with a respective subscription field 232c, 234c, 236c, 238c and unsubscription field 232d, 234d, 236d, 238d through which a user may elect to subscribe or unsubscribe from a given source of media content. In embodiments, a user to which a viewer is subscribed in this manner may receive an alert or notification relating to an action of the user on media distribution system 1000, such as a connection to media server 300 across a data network 400 or transmission of media content to media server 300, to name a few. In embodiments, subscriptions to a particular user or group of users may be continuing so that upon authorization a viewer may access media content generated by the user or group of users at any time, or may be renewable so that a viewer's subscription applies only to a single instance of media content.

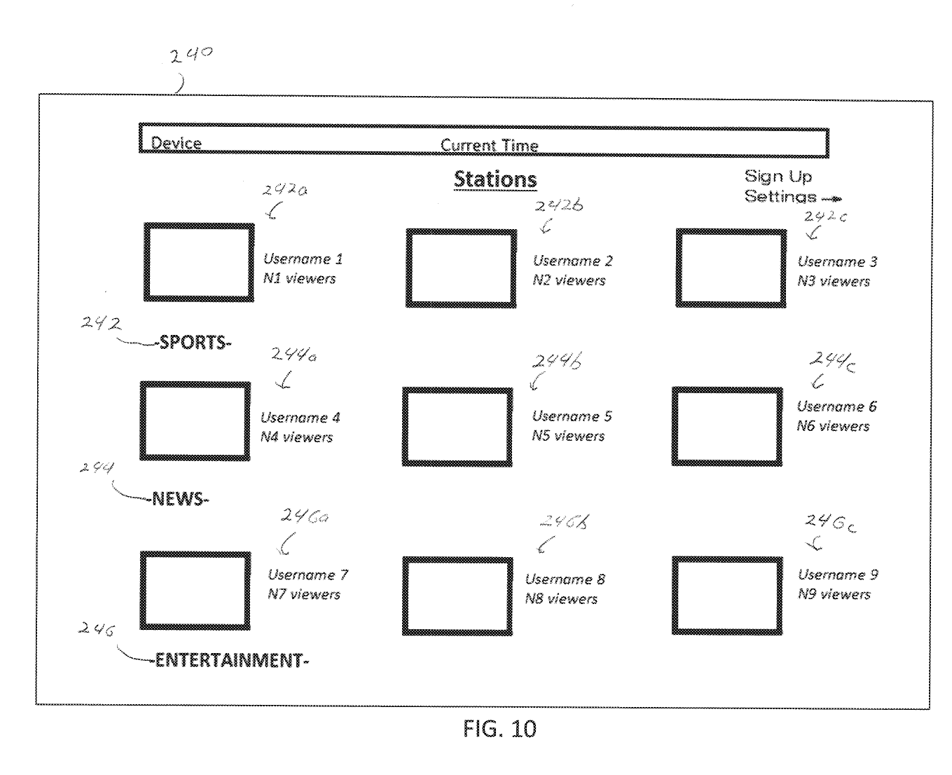

Turning to FIG. 10, an exemplary embodiment of a graphic user interface, designated 240, is shown. Graphic user interface 240 may provide a viewer with information regarding sources of media content grouped by a common identifier, for example topic or subject matter. As shown, graphic user interface 240 includes common identifiers 242, 244, 246 corresponding to sports, news, and entertainment, respectively. In embodiments, common identifiers may include, for example, animals, politics, gardening, parenting, and/or education, to name a few. Common identifiers 242, 244, 246 may be associated with respective pluralities 242a, 242b; 244a, 244b, 244c; and 246a, 246b, 246c of sources of media content, and may include any form of identifying information, for example, a representative still image or movie clip of any length, associated username, associated social network, and/or number of views, to name a few.

Accordingly, it will be understood that graphic user interfaces as described herein may provide a viewer and/or user with information and/or with an interface through which to control one or more operations of at least a portion of media distribution system 1000.

In embodiments, one such viewer-designated setting comprises a filter for displaying media content of a particular type or content. In an exemplary embodiment, a filter may be provided such that only live-streaming media content is provided for a viewer's selection. In an exemplary embodiment, a filter may be provided to display media content of an educational purpose is isolated for a viewer, for example, academics, home improvement, guided tours, fashion advice, sports instruction, automotive mechanics, first aid and/or medicine, computer troubleshooting, and/or instructions relating to online retail business, to name a few.

In embodiments, a viewer may be provided with the option to communicate with the associated user media device of a given media content. For example, a viewer may, via a graphic user interface as provided herein, supply a text-based message that appears on a corresponding display of the user device. In such embodiments where more than one viewer is connected to a given user device, a voting system may be implemented such that only a most-voted message is transmitted to the user media device. In embodiments, a viewer may transmit an audio message to a given user device such that the audio message is audible to the user and/or to an area surrounding the user.

In embodiments, user-, viewer-, and/or system-designated restrictions may be placed on the transmission and/or access of selected types of media content. For example, media content related private areas such as bathroom or locker room facilities may be restricted from transmission and/or access on media distribution system 1000. In embodiments, selected or non-authorized individuals may be anonymized in media content distributed across system 1000, for example, the faces of individual persons may be blurred or pixelated in media content distributed across system 1000. In embodiments, a user may override a subscription of a viewer such that the viewer can no longer access media content generated by the user's media device.

While this invention has been described in conjunction with the embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

1. A media distribution system, comprising:
a head-mounted user media device including at least one sensor substantially aligned with a user's field of view and configured to generate media content;
a plurality of viewer media devices configured to display media content from the head-mounted user media device;
a media server interconnecting the head-mounted user media device and the plurality of viewer media devices across a data network, the media server comprising a processor to implement one or more criteria provided by the user such that one or more selected viewer media devices can receive media content from the head-mounted user media device through the media server.

2. The media distribution system of claim 1, wherein the media content comprises video.

3. The media distribution system of claim 2, wherein the media content comprises audio.

4. The media distribution system of claim 1, wherein the head-mounted user media device comprises a display.

5. The media distribution system of claim 4, wherein the display comprises media content generated from the sensor.

6. The media distribution system of claim 4, wherein the display comprises a graphic user interface which displays information relating to one or more components of the media distribution system.

7. The media distribution system of claim 1, wherein the head-mounted user media device comprises a transmitter such that media content from the head-mounted user media device can be transmitted across the data network substantially in real-time.

8. The media distribution system of claim 1, wherein the one or more criteria comprises a subscription.

9. A media distribution system, comprising:
a plurality of head-mounted user media devices, each including at least one sensor substantially aligned with a respective user's field of view and configured to generate media content;
a viewer media device configured to display media content from each of the head-mounted user media devices to a viewer;
a media server interconnecting the plurality of head-mounted user media devices and the viewer media device across a data network, the media server comprising a processor to implement one or more criteria provided by the viewer such that media content from one or more of the plurality of head-mounted user media devices is provided for selection by the viewer.

10. The media distribution system of claim 9, wherein the one or more of the plurality of head-mounted user media devices comprises less than the plurality of head-mounted user media devices.

11. The media distribution system of claim 9, wherein the media content comprises video.

12. The media distribution system of claim 11, wherein the media content comprises audio.

13. The media distribution system of claim 9, wherein the viewer media device comprises a graphic user interface which displays information relating to one or more components of the media distribution system.

14. The media distribution system of claim 9, wherein the one or more criteria comprises a common identifier.

15. The media distribution system of claim 14, wherein the common identifier is a topic.

16. The media distribution system of claim 14, wherein the common identifier is media content that is transmitted substantially in real-time.

17. A method of using a head-mounted user-media device, comprising:
(a) providing a head-mounted user media device mounted in substantial alignment with a user's field of view and comprising a sensor configured to generate media content and a transmitter to transmit media content across a data network;
(b) activating the sensor such that media content is generated;
(c) transmitting the media content across the data network to a media server substantially in real-time; and
(d) selecting one or more criteria determining access of the media content from the media server by one or more viewers.

18. The method of claim 17, wherein the step of selecting one or more criteria includes the one or more criteria being a subscription.

19. The method of claim 17, wherein the step of activating the sensor includes speaking by the user a voice command.
